(19) United States
(12) Patent Application Publication
(10) Pub. No.: US 2009/0019014 A1
(43) Pub. Date: Jan. 15, 2009

(54) Multidimensional database structuring method, multidimensional database structuring system and information processing apparatus

(75) Inventor: Kei Sugimoto, Osaka (JP)

Correspondence Address: BIRCH STEWART KOLASCH & BIRCH, PO BOX 747, FALLS CHURCH, VA, 22040-0747, US

(73) Assignee: WATERMARK APPLICATIONS CO., LTD.

(21) Appl. No.: 12/216,453

(22) Filed: Jul. 3, 2008

(30) Foreign Application Priority Data
Jul. 5, 2007 (JP) 2007-177494

(51) Int. Cl. G06F 7/06; G06F 17/30

(52) U.S. Cl. 707/3; 707/E17.014

(57) ABSTRACT

Version identification information for identifying the version of content data stored in a multidimensional database is generated preliminarily. When the version identification information of a predetermined version, multidimensional identification information (information indicating the combination of members) and update data are received, the content data updated on the basis of the update data is stored in a version management table so as to be associated with the version identification information of the predetermined version and the multidimensional identification information. The content data of the predetermined version is identified on the basis of the version identification information and the multidimensional identification information.

### CROSS-REFERENCE TO RELATED APPLICATIONS

This Nonprovisional application claims priority under 35 U.S.C. §119(a) on Patent Application No. 2007-177494 filed in Japan on Jul. 5, 2007, the entire contents of which are hereby incoroporated by reference.

### BACKGROUND OF THE INVENTION

The present invention relates to a multidimensional database structuring method, a multidimensional database structuring system and an information processing apparatus capable of managing the versions of stored content data.

Conventionally, advanced analysis can be carried out from various points of view using a multidimensional database, and such a multidimensional database is shared among the client apparatuses of various departments in a corporation, for example, in on-line analytical processing (hereinafter referred to as OLAP (On-Line Analytical Processing)), and widely used as supporting means for making decisions among the departments.

FIG. 1 is a conceptual view illustrating a conventional multidimensional database. A multidimensional database has basic components referred to as cubes. A cube is formed of multiple dimensions so that data can be subdivided and analyzed from various perspectives. A dimension is formed of arbitrary members assumed by the user to belong to the same concept. Furthermore, the hierarchic structure of the members constituting a dimension is defined. In the multidimensional database, aggregation is carried out according to the structure of the members forming the dimension.

FIG. 1 shows an example in which “account,” “commodity” and “year” are used as dimensions. In addition, the dimension “account” is formed of three members, “sales amount,” “sales cost” and “sales profit.” Furthermore, the dimension “commodity” is formed of three members, “CD,” “DVD” and “video.” Moreover, the dimension “year” is formed of three members, “2006,” “2007” and “2008.” A multidimensional database having “commodity profitability” is structured by combining the three dimensions.

In the multidimensional database, multiple members such as “2006, sales amount and CD” selected from the dimensions are combined, whereby coordinates in the cube are represented. At the represented coordinate, a cell corresponding thereto is present, and content data, such as a numeric value, a money amount or a character string, is stored in the cells.

The hierarchic structure of the members defined by a dimension of the multidimensional database is a structure for deriving the total, maximum, minimum, average or the like of the content data represented by child members as the content data represented by their parent member. Hence, the content data represented by a child member cannot be derived from the content data represented by its parent member. For example, FIG. 1 shows an example in which the member “sales profit” belonging to the dimension “account” is the parent member of the members “sales amount” and “sales cost” and the total of the content data of the two members “sales amount” and “sales cost” is the content data of the parent member “sales profit.”

In the conventional multidimensional database, however, a need for managing the versions of content data may arise. For example, in the budget compilation activities of a corporation, working data (child version) is prepared for each department on the basis of common base data (parent version), and each department modifies the working data. In addition, the respective working data is required to be updated without being interfered by updates to other working data and reflected to the base data when the content of the data is settled. Furthermore, the parent-child relationship of the version is required to have a multi-level hierarchy to reflect the corporation's organization structure having a multi-level hierarchy. In the case that such version management is required, a common solution method using the conventional multidimensional database technology is to prepare a working database for each department by copying the whole multidimensional database storing the base data. However, this kind of method is disadvantageous in that effort for ensuring data consistency among the copied multiple databases is enormous and that the use of the method becomes difficult as the number of involved departments increases. Furthermore, since the whole data including those not to be changed is also required to be copied even though the data to be changed in each child version is only a small portion of the whole data of the parent version, there occurs a problem in which the processing time becomes long and a large capacity is required for storage media. Hence, it is desired that data is managed for each version in a single multidimensional database and that only the difference from the parent version is stored for each version.

Accordingly, when a method for carrying out the version management of content data in one multidimensional database is considered on the assumption that the conventional multidimensional database technology is used, the version is stored as a dimension. In this case, it is seemingly possible to represent the hierarchic structure of versions by positioning parent versions as parent members and child versions as child members, respectively.

However, in the case that the dimensions are used, as described above, the content data of the parent member is derived from the content data of the child members. On the other hand, in the case of version management, the content data of the child version is required to be derived from the content data of the parent version and the difference data. Hence, the parent-child relationship among members and the parent-child relationship in version management are common in that they have a hierarchic structure but are opposite in the direction of deriving data. Therefore, it is unreasonable to represent the versions as a dimension, and the version management of content data in a single multidimensional database cannot be carried out on the assumption that the conventional multidimensional database technology is used.

To solve this problem, a method described below has been proposed in which a multidimensional database is partitioned into a “base partition” for base values and a “write-back partition” for difference values, each client apparatus updates only the difference values of the “write-back partition” while referring to the basic values of the “base partition,” the basic values of the “base partition” are overwritten with the difference values of the “write-back partition” after the updating is completed, and the overwritten basic values of the “base partition” are used as data to be disclosed (for example, prior art document: U.S. Pat. No. 7,016,912).

### BRIEF SUMMARY OF THE INVENTION

In the method described in the prior art document, since content data is derived from the basic value of the “base partition” serving as a parent version and the difference value of the “write-back partition” serving as a child version, it is possible to avoid a situation in which the parent version is updated when the child version is updated.

However, the method described in the prior art document cannot sufficiently meet common needs, such as the budget compilation activities of a corporation. Firstly, in the budget compilation activities, working data is required to be divided into versions, each of which is tied to a department or other unit. Since the data of the “write-back partition” is tied only to the user and the date and time of update in the method described in the prior art document, there occurs a problem in which the method cannot be applied to a case wherein multiple users cooperatively take charge of the activities of one department or a case wherein one user takes charge of the activities of multiple departments simultaneously.

Secondly, since the parent-child relationship among versions is limited to have two hierarchic levels in the method described in the prior art document, there occurs a problem in which the method cannot be used for corporations requiring the parent-child relationship having multiple hierarchic levels because of the organization structure thereof. For example, in the case that data is disclosed stepwise such that after the working data of a branch is settled, the working data is disclosed to all the sales departments and then after the working data is examined by the sales departments, the working data is disclosed to the whole corporation, there occurs a problem in which the method described in the prior art document is difficult to deal with this kind of case.

In consideration of these circumstances, an object of the present invention is to provide a multidimensional database structuring method in which content data is stored in a multidimensional database so as to be associated with version identification information for identifying the version of the content data and the combination of members, the version identification information for identifying a predetermined version is recorded so as to be associated with the version identification information of the parent version at a hierarchic level higher than that of the predetermined version, and the version management of the content data can be carried out appropriately on the basis of the association with the recorded version and the combination of the members, and also provide a multidimensional database structuring system for carrying out the method and an information processing apparatus for use in the system.

To solve the problems described above, a multidimensional database structuring method according to the present invention for identifying content data stored in a multidimensional database classified according to dimensions formed of a set of members on the basis of the combination of the members, comprises steps of storing content data in the multidimensional database so as to be associated with version identification information for identifying the version of the content data and the combination of the members; recording the version identification information of a predetermined version so as to be associated with the version identification information of the parent version at a hierarchic level higher than that of the predetermined version; and identifying content data of the predetermined version on the basis of the association with the recorded version and the combination of the members.

In addition, a multidimensional database structuring system according to the present invention comprises a multidimensional database classified according to dimensions formed of a set of members and an information processing apparatus connected to the multidimensional database, the information processing apparatus having storing means for storing content data in the multidimensional database and identifying means for identifying the stored content data on the basis of the combination of the members; wherein the multidimensional database includes a first data structure in which content data is associated with version identification information for identifying the version of the content data and the combination of the members; and a second data structure in which the version identification information of a predetermined version and the version identification information of the parent version at a hierarchic level higher than that of the predetermined version are associated with each other; wherein the information processing apparatus comprises recording means for recording the version identification information for identifying the predetermined version so as to be associated with the version identification information of the parent version at a hierarchic level higher than that of the predetermined version in the second data structure; wherein the storing means stores content data of the predetermined version in the first data structure so as to be associated with the version identification information and the combination of the members, and the identifying means identifies the content data of the predetermined version on the basis of the first data structure, the second data structure and the combination of the members.

Furthermore, the multidimensional database structuring system according to the present invention is characterized in that the first data structure and the second data structure are components of tables.

Moreover, the multidimensional database structuring system according to the present invention is characterized in that the content data stored in the first data structure is the difference between the content data of the predetermined version and the content data of the parent version at a hierarchic level higher than that of the predetermined version.

Still further, the information processing apparatus according to the present invention to be connected to a database capable of storing content data classified according to dimensions formed of a set of members, comprises storing means for storing content data in the connected database; identifying means for identifying the stored content data according to the combination of the members; and recording means for recording the version identification information of a predetermined version so as to be associated with the version identification information of the parent version at a hierarchic level higher than that of the predetermined version; wherein the storing means stores content data of the predetermined version so as to be associated with the version identification information and the combination of the members, and the identifying means identifies the content data of the predetermined version on the basis of the association with the recorded version and the combination of the members.

With the present invention, in a multidimensional database, content data is stored so as to be associated with the version identification information and the combination of the members, the version identification information of a predetermined version is recorded so as to be associated with the version identification information of the parent version at a hierarchic level higher than that of the predetermined version, and the content data of the predetermined version is identified on the basis of the association with the stored version and the combination of the members. Working data stored in respective child versions can be updated without being interfered with one another, for example, by identifying content data as separate data in terms of version. In addition, for example, the updating authority for one version can be given to multiple users or the updating authority for multiple versions can be given to one user, whereby flexible work allocation can be attained. Furthermore, the result of updating the parent version can be spread to all the child versions by setting a parent-child relationship among the versions and by storing only the difference data that is different from the data of the parent version into the child version. For example, data can be disclosed stepwise such that after the working data of a branch is settled, the working data is disclosed to all the sales departments and then after the working data is examined by the sales departments, the working data is disclosed to the whole corporation. Moreover, the amount of data to be stored in the information processing apparatus can be reduced by storing only differences between versions for content data in a single multidimensional database in comparison with a case in which the whole multidimensional database is copied as many as the number of versions. Still further, when the dimensions are corrected, the correction can be reflected immediately to all the versions, whereby operational burden can be reduced.

With the present invention, the versions of content data stored in a multidimensional database can be managed appropriately. In addition, flexible work allocation can be attained by assigning version updating authority to the users. Furthermore, working data can be disclosed stepwise, and the range (hierarchic levels) in a organization to which data is disclosed can be managed appropriately. Moreover, the amount of data to be stored in the information processing apparatus can be reduced, and the operational burden at the time of dimension correction can be reduced.

The above and further objects and features of the invention will more fully be apparent from the following detailed description with accompanying drawings.

### BRIEF DESCRIPTION OF THE SEVERAL VIEWS OF THE DRAWINGS

FIG. 1 is a conceptual view illustrating the conventional multidimensional database;

FIG. 2 is a schematic view showing the overall configuration of a multidimensional database structuring system according to the present invention;

FIG. 3 is a schematic view showing a usage example of the multidimensional database structuring system according to the present invention;

FIG. 4 is a conceptual view illustrating a multidimensional database being used for the present invention;

FIG. 5 is a conceptual view showing an example for illustrating a first data structure according to Embodiment 1;

FIG. 6 is a conceptual view showing an example for illustrating a second data structure;

FIG. 7 is a conceptual view showing an example of the hierarchic structure of version identification information;

FIG. 8 is a flowchart showing a retrieval procedure carried out by an information processing apparatus according to Embodiment 1;

FIG. 9 is a flowchart showing an updating procedure carried out by the information processing apparatus according to Embodiment 1;

FIG. 10 is a conceptual view showing an example for illustrating a first data structure according to Embodiment 2;

FIGS. 11A and 11B are flowcharts showing a retrieval procedure carried out by an information processing apparatus according to Embodiment 2; and

FIG. 12 is a flowchart showing an updating procedure carried out by the information processing apparatus according to Embodiment 2.

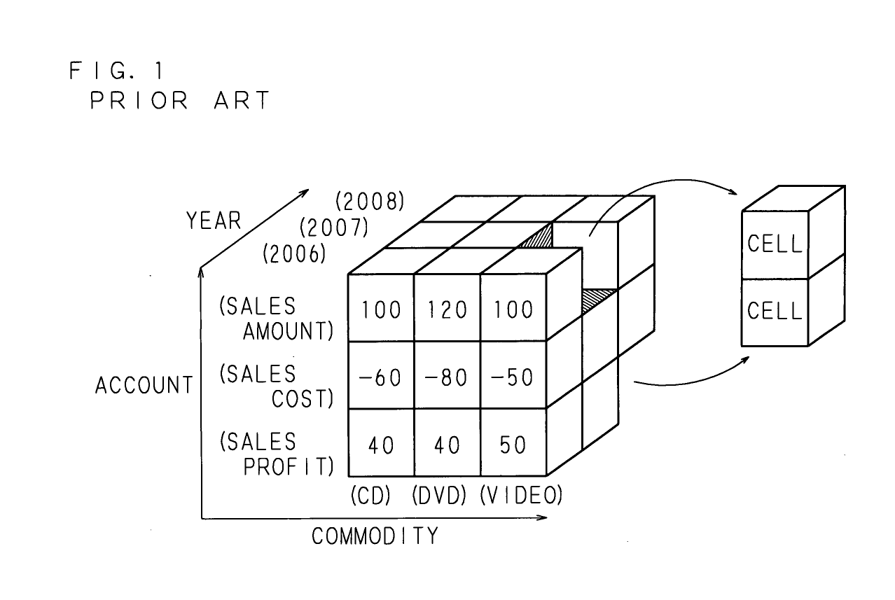

### DETAILED DESCRIPTION OF THE INVENTION

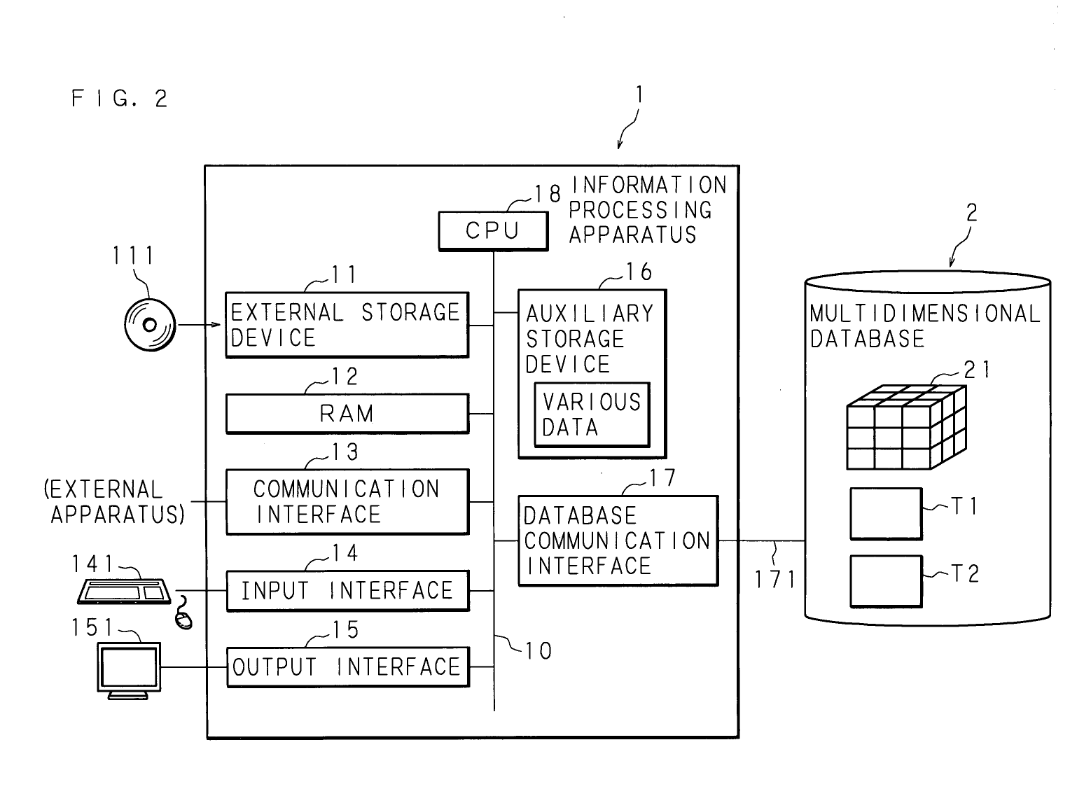

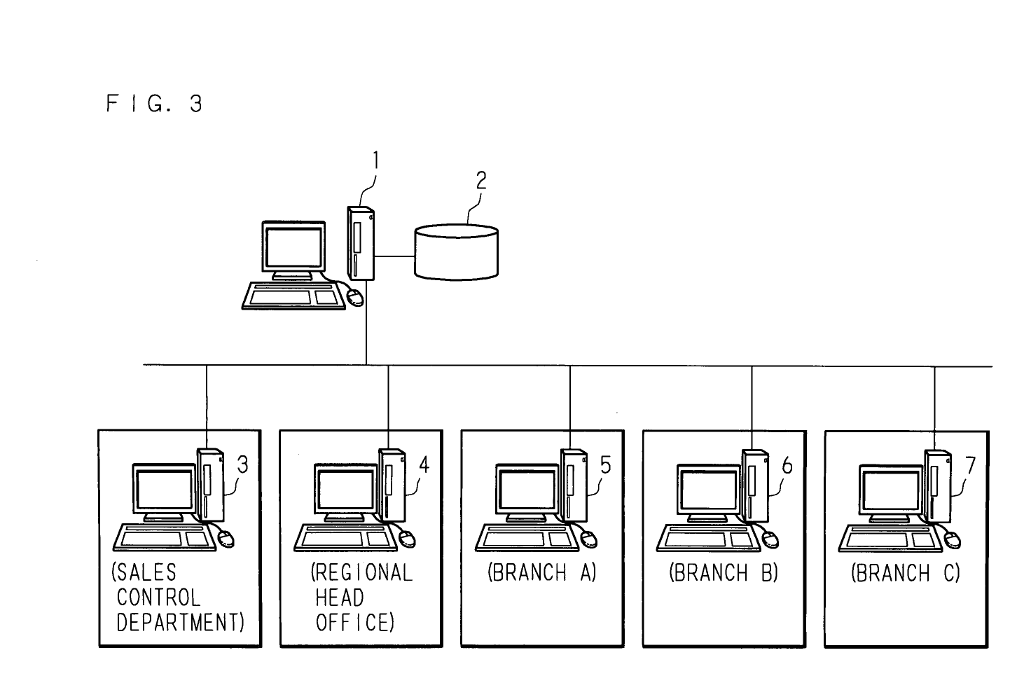

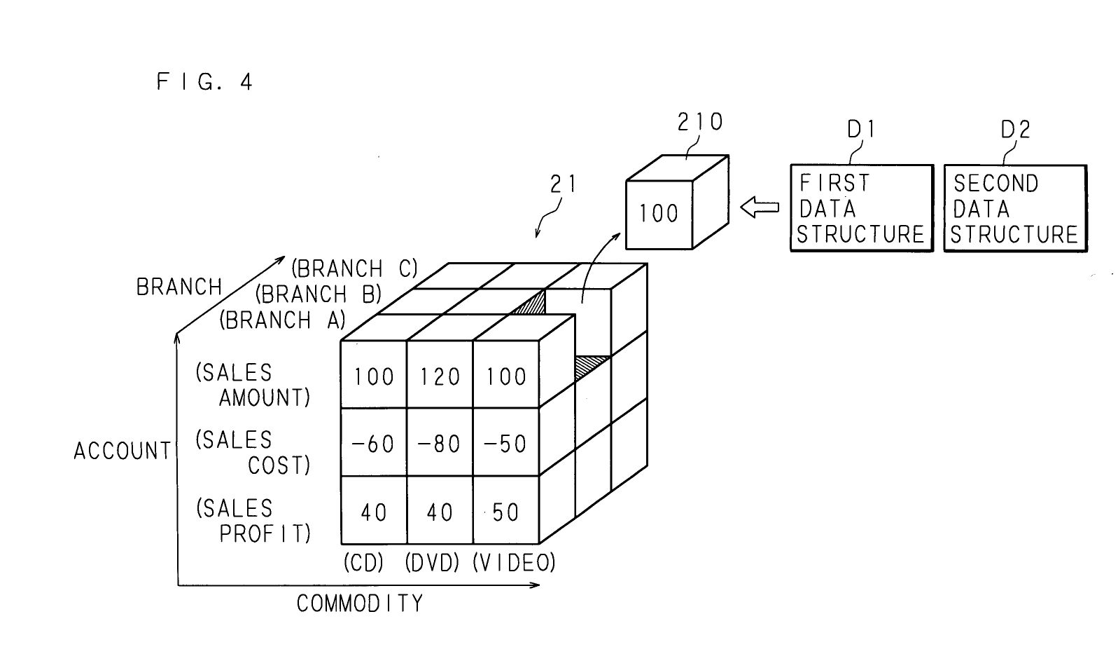

A multidimensional database structuring method according to the present invention, a multidimensional database structuring system for carrying out the method and an information processing apparatus for use in the system will be described below on the basis of the drawings showing embodiments. FIG. 2 is a schematic view showing the overall configuration of the multidimensional database structuring system according to the present invention, FIG. 3 is a schematic view showing a usage example of the multidimensional database structuring system according to the present invention, and FIG. 4 is a conceptual view illustrating a multidimensional database 2 being used for the present invention. In this embodiment, an example in which the multidimensional database 2 is configured so as to be separate from the information processing apparatus 1 is described. However, the configuration of the present invention is not limited to this configuration, but a configuration in which the multidimensional database 2 is incorporated in the information processing apparatus 1 may also be used.

As shown in FIG. 2, the multidimensional database structuring system according to the present invention comprises the information processing apparatus 1 and the multidimensional database 2. The information processing apparatus 1 is an apparatus for executing various processes, such as storage of content data into the multidimensional database 2 and retrieval of content data from the multidimensional database 2, and comprises an external storage device 11, a RAM 12, a communication interface 13, an input interface 14, an output interface 15, an auxiliary storage device 16, a database communication interface 17 and a CPU 18. The hardware devices are mutually connected via a bus 10.

The external storage device 11 is a unit for reading programs or data stored on a portable recording medium 111, such as a DVD (Digital Versatile Device) or a CD (Compact Disc). When the recording medium 111 is inserted, the external storage device 11 reads programs, etc. from the inserted recording medium 111 and transmits the read programs, etc. to the auxiliary storage device 16. On the recording medium 111, programs and various data for causing the CPU 18 to carry out a multidimensional database management method according to the present invention are recorded.

The RAM 12 is formed of an SRAM or DRAM. The RAM 12 stores, for example, the programs read from the auxiliary storage device 16 and various data generated by executing the programs. The communication interface 13 is a terminating device of a communication network, such as the Internet or an intranet and serves as a window for communicating with external apparatuses that can be connected via the communication network. The communication interface 13 receives data, requests, instructions, etc. transmitted from the external apparatuses and transmits the received data, etc. to the RAM 12.

In this embodiment, an example is described in which the external apparatuses are the client apparatuses 3 of the sales control department of the head office, the client apparatus 4 of a regional head office, the client apparatus 5 of branch A, the client apparatus 6 of branch B and the client apparatus 7 of branch C (see FIG. 3).

An input device 141 is connected to the input interface 14. The input device 141 is, for example, a keyboard or a mouse, and has multiple operation buttons (not shown). When an operation button is pressed, the signal corresponding to the pressed button is generated. The input device 141 receives the generated signal as information and transmits the received information to the RAM 12 via the input interface 14. The RAM 12 stores the received information.

The output interface 15 is connected to an output device 151. The output interface 15 converts various data stored in the RAM 12 into images and sounds and outputs the converted images and sounds via the output device 151. The output device 151 is, for example, a CRT, liquid crystal display monitor or sound speaker. The output device 151 outputs information for managing the multidimensional database 2.

The auxiliary storage device 16 is, for example, a magnetic storage hard disk drive. In the auxiliary storage device 16, programs and various data read from the recording medium 111 are stored. The database communication interface 17 is a device for connection to the multidimensional database 2 via a cable 171 and reads various data from the multidimensional database 2 or writes various data into the multidimensional database 2 according to instructions from the CPU 18. The CPU 18 controls various hardware devices constituting the information processing apparatus 1 to cause the information processing apparatus 1 to carry out the multidimensional database structuring method according to the present invention.

The multidimensional database 2 has a basic component referred to as a cube 21 so that data can be analyzed from various perspectives in combination with multiple dimensions. The cube 21 is formed of multiple dimensions. A dimension is formed of arbitrary members assumed to belong to the same concept. Furthermore, in the multidimensional database 2, the hierarchic structure of the members forming a dimension is defined, and aggregation is carried out according to the defined hierarchic structure.

Moreover, the multidimensional database 2 indicates coordinates (x, y, z) in the cube 21 by combining multiple members extracted from the dimensions forming the cube 21. As shown in FIG. 4, a cell 210 corresponding to the indicated coordinates is present, and content data is stored in each cell 210. The content data is a value managed by the multidimensional database 2, and may be a numeric value, a money amount, a character string or the like.

The stored content data is managed so as to be associated with version identification information and multidimensional identification information according to the first data structure D1 of the multidimensional database 2. Furthermore, the hierarchic structure of the version of the content data is managed according to the second data structure D2 of the multidimensional database 2.

In this embodiment, an example of a cube “commodity profitability” formed of the combination of three dimensions, “account,” “commodity” and “branch,” is shown (see FIG. 4). The dimension “account” is formed of three members, “sales amount,” “sales cost” and “sales profit.” Furthermore, the dimension “commodity” is formed of three members, “CD,” “DVD” and “video.” Moreover, the dimension “branch” is formed of three members, “branch A,” “branch B” and “branch C.”

Furthermore, in the multidimensional database 2, a version management table T1 in which version identification information, content data and the combination of members indicating the content data are stored so as to be associated with one another and a hierarchic structure table T2 for managing the hierarchic structure of the version are stored as described later.

### EMBODIMENT 1

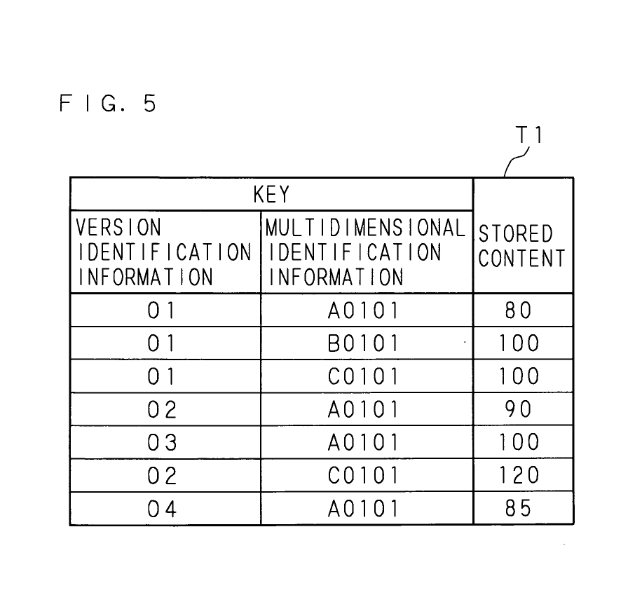

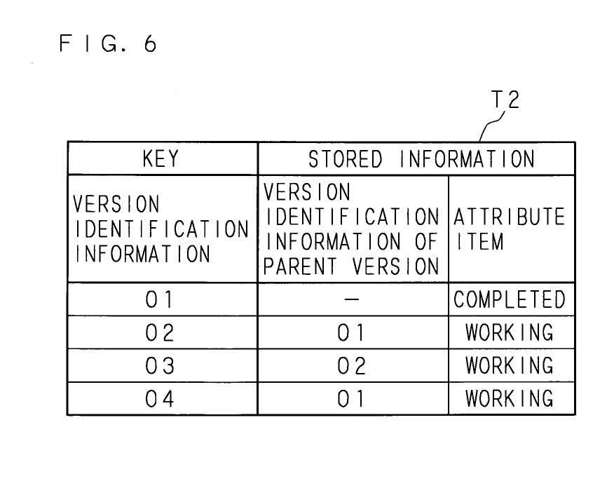

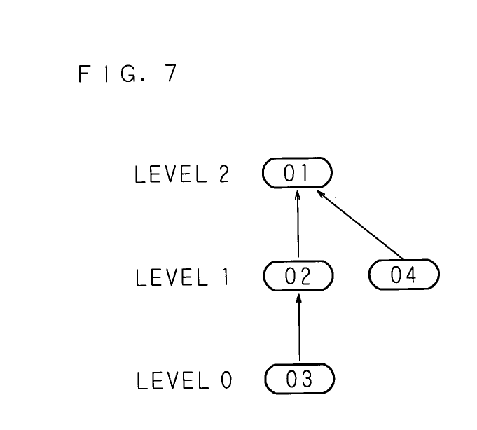

Next, the first data structure D1 and the second data structure D2 of the multidimensional database 2 will be described below. FIG. 5 is a conceptual view showing an example for illustrating the first data structure D1 according to Embodiment 1, FIG. 6 is a conceptual view showing an example for illustrating the second data structure D2, and FIG. 7 is a conceptual view showing an example of the hierarchic structure of the version identification information. In this embodiment, an example in which the first data structure D1 and the second data structure D2 are components of the tables is described.

In FIG. 5, T1 is a version management table for managing the version of the content data and has the first data structure D1. In the version management table T1, the version identification information (key), the multidimensional identification information (key) and stored content are stored so as to be associated with one another for each record.

The version identification information is information for identifying the version of content data to be newly stored or updated and is generated so that each version is identified uniquely. The version identification information is generated as “01,” “02,” “03” or “04,” for example. The version identification information is generated by the information processing apparatus 1 according to instructions from the user, and is associated with the content data. However, without being limited to this, it may be possible that the version identification information is automatically generated by the information processing apparatus 1 in which the content data is newly stored or updated and that the version identification information is associated with the content data.

The multidimensional identification information is information indicating the combination of members extracted from each dimension constituting the multidimensional database 2. In the multidimensional identification information, for example, as shown in FIG. 5, the content data in the cell of the members “branch A, sales amount and CD” is numbered “A101,” and the content data in the cell of the members “branch B, sales amount and CD” is numbered “B0101,” and the content data in the cell of the members “branch C, sales amount and CD” is numbered “C0101.” The stored content is content data itself and newly stored and updated content data.

In FIG. 6, T2 is a hierarchic structure table for managing the hierarchic structure of the version and has the second data structure D2. In the hierarchic structure table T2, the version identification information (key), the version identification information of the parent version and an attribute item are stored so as to be associated with one another for each record. The version identification information is information for uniquely identifying the version of the content data to be newly stored and updated and corresponds to the item of the same name in the version management table T1.

The version identification information of the parent version is information for identifying the version of the parent content data having a parent-child relationship with the content data indicated by the version identification information. For example, in the figure, the parent of version identification information 03 is version identification information 02, the parent of the version identification information 02 is version identification information 01, the version identification information 01 is the highest-level parent, and the parent of version identification information 04 is the version identification information 01 (see FIG. 7).

The attribute item is information for distinguishing the kind of version and indicates, for example, whether the content data of the corresponding version is working data or completed data. For example, in the figure, the version identification information 02, 03 and 04 are working data, and the version identification information 01 is completed data.

The hierarchic structure indicated by the hierarchic structure table T2 does not circulate. In addition, only in the case that the content data of each version is different from the content data of its parent version for each piece of multidimensional information, the content data of the version is stored in the version management table T1. Hence, in the case that the data of the parent version is updated, the change is spread to its child version (except the case in which the data of the child version has been changed). On the other hand, in the case that the data of the child version is updated, the change is not spread to the parent version. Hence, in the present invention, for example, in the case that the data of the lowest-level version (for example, the version identification information 03) of a branch in budget compilation is updated, the change is not reflected to the data of the lowest-level version (for example, the version identification information 04) of another branch. On the other hand, when the budget draft of each branch is settled, by reflecting its content to the parent version (the version identification information 01) of the sales control department, the content is reflected to the data of all the branches. In this way, one branch can update its working data without affecting the data that is referred to by other branches. In addition, cooperation of work can be accomplished in such a way that the data is shared among the sales departments when it is settled.

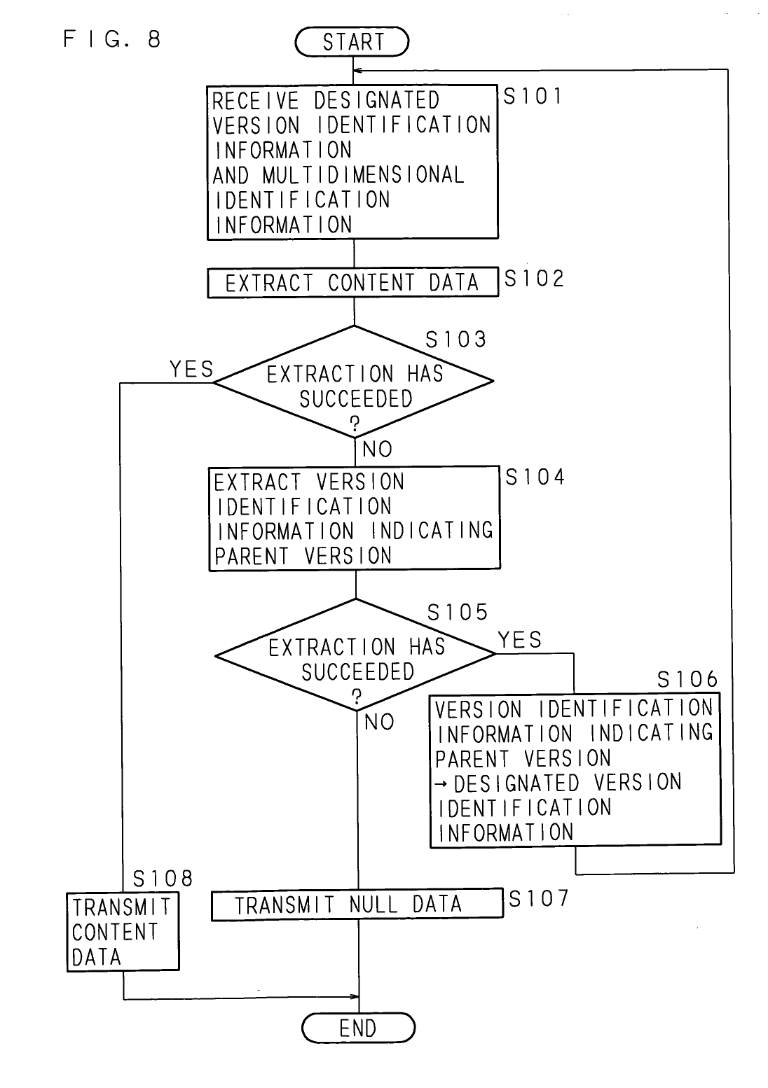

Next, the retrieval of content data stored in the multidimensional database 2 will be described below. FIG. 8 is a flowchart showing a retrieval procedure carried out by the information processing apparatus 1 according to Embodiment 1. For example, the user of the sales control department designates arbitrary version identification information and multidimensional identification information via the client apparatus 3 to access the working data or completed data of each branch. The client apparatus 3 receives the designated version identification information and multidimensional identification information and transmits the received version identification information and multidimensional identification information to the information processing apparatus 1.

The CPU 18 of the information processing apparatus 1 receives the designated version identification information and multidimensional identification information (at S101). The CPU 18 accesses the version management table T1 stored in the multidimensional database 2 and extracts the content data corresponding to the version identification information and multidimensional identification information from the accessed version management table T1 (at S102). The CPU 18 judges whether the extraction of the content data has succeeded (at S103). As a result, when the CPU 18 judges that the extraction of the content data has succeeded (YES at S103), the extracted content data is transmitted to the client apparatus 3 (at S108), and the retrieval procedure ends. The client apparatus 3 receives the content data transmitted from the information processing apparatus 1.

On the other hand, when the CPU 18 judges at step S103 that the extraction of the content data has failed (NO at S103), the CPU 18 accesses the hierarchic structure table T2 stored in the multidimensional database 2 and extracts the version identification information indicating the parent version from the accessed hierarchic structure table T2 (at S104). The CPU 18 judges whether the extraction of the version identification information indicating the parent version has succeeded (at S105). As a result, when the CPU 18 judges that the extraction of the version identification information has succeeded (YES at S105), the designated version identification information is replaced with the version identification information indicating the parent version (see S101) (at S106), and the operation returns to step S101, and the retrieval procedure is repeated.

On the other hand, when the CPU 18 judges that the extraction of the version identification information indicating the parent version has failed (NO at S105), the CPU 18 transmits null data to the client apparatus 3 (at S107), and the retrieval procedure ends. Upon receiving the null data transmitted from the information processing apparatus 1, the client apparatus 3 judges that the content data indicated by the version identification information and multidimensional identification information designated by the user have not been stored in the multidimensional database 2.

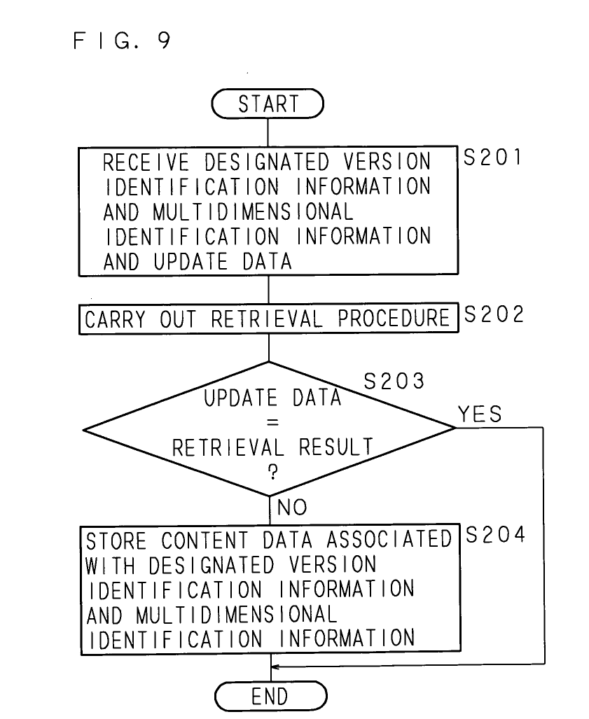

Next, the updating of content data stored in the multidimensional database 2 will be described below. FIG. 9 is a flowchart showing an updating procedure carried out by the information processing apparatus 1 according to Embodiment 1. For example, the users of the respective departments designate arbitrary version identification information and multidimensional identification information via the client apparatuses 4 to 7 to access the working data and input update data. The client apparatuses 4 to 7 receive the designated version identification information and multidimensional identification information and the update data and transmit the received version identification information, multidimensional identification information and the update data to the information processing apparatus 1.

The CPU 18 of the information processing apparatus 1 receives the designated version identification information and multidimensional identification information and the update data (at S201). The CPU 18 accesses the version management table T1 stored in the multidimensional database 2 and carries out the above-mentioned retrieval procedure (see FIG. 8) (at S202).

The CPU 18 judges whether the received update data is the same as the retrieval result, i.e., the content data extracted by the above-mentioned retrieval procedure (at S203). As a result, when the CPU 18 judges that the update data is not the same as the retrieval result (NO at S203), the CPU 18 stores the content data updated on the basis of the update data into the version management table T1 in the multidimensional database 2 so that the updated content data is associated with the designated version identification information and multidimensional identification information (at S204), and the updating procedure ends.

On the other hand, when the CPU 18 judges that the update data is the same as the retrieval result (YES at S203), the updating procedure ends without updating the content data on the basis of the update data.

### EMBODIMENT 2

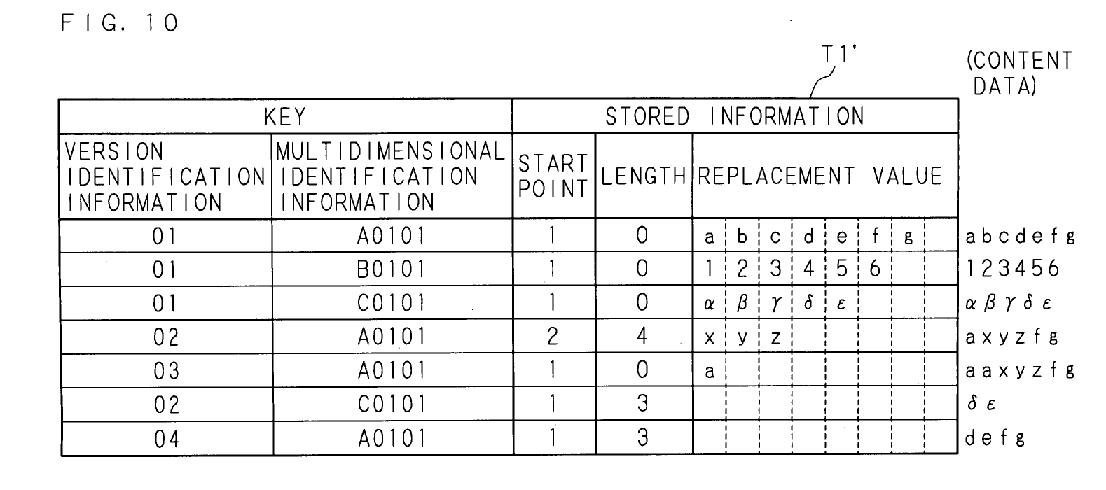

In Embodiment 1 described above, an example in which content data itself is stored in the version management table T1 is described; however, the present invention is not limited to this example. In Embodiment 2, an example is described in which the difference between the content data of the version indicated by the version identification information and the content data of the parent version at a hierarchic level higher than that of the version is stored in a version management table T1′. FIG. 10 is a conceptual view showing an example for illustrating a first data structure D1 according to Embodiment 2.

In FIG. 10, T1′ is a version management table for managing the version of the content data and has the first data structure D1. In the version management table T1′, the version identification information (key), the multidimensional identification information (key) and stored information are stored so as to be associated with one another for each record. The stored information is the difference between the content data of the version indicated by the version identification information and the content data of the parent version at a hierarchic level higher than that of the version. The stored information includes start point, length and replacement value. The content data in a version is represented by deleting a character string having the start point and the length included in the stored information from the content data in the parent version and by inserting the replacement value into the deleted portion.

For example, when content data “abcdefg” is newly stored in the cell “A0101” for the version designated by version identification information “01,” start point 1, length 0 and replacement value “abcdefg” are stored as the stored information.

Next, when the content data in the cell “A0101” is updated to “axyzfg” for the version designated by version identification information “02,” start point 2, length 4 and replacement value “xyz” are stored as the stored information. Furthermore, when the content data in the cell “A0101” is updated to “aaxyfg” for the version designated by version identification information “03,” start point 1, length 0 and replacement value “a” are stored as the stored information. Moreover, when the content data in the cell “A0101” is updated to “defg” for the version designated by version identification information “04,” start point 1 and length 3 are stored as the stored information, and null data is stored as the replacement value. In other words, since the parent version of the version designated by the version identification information “04” is the version designated by the version identification information “01,” the difference from the content data “abcdefg” in the cell “A0101” in the parent version is stored in the stored information.

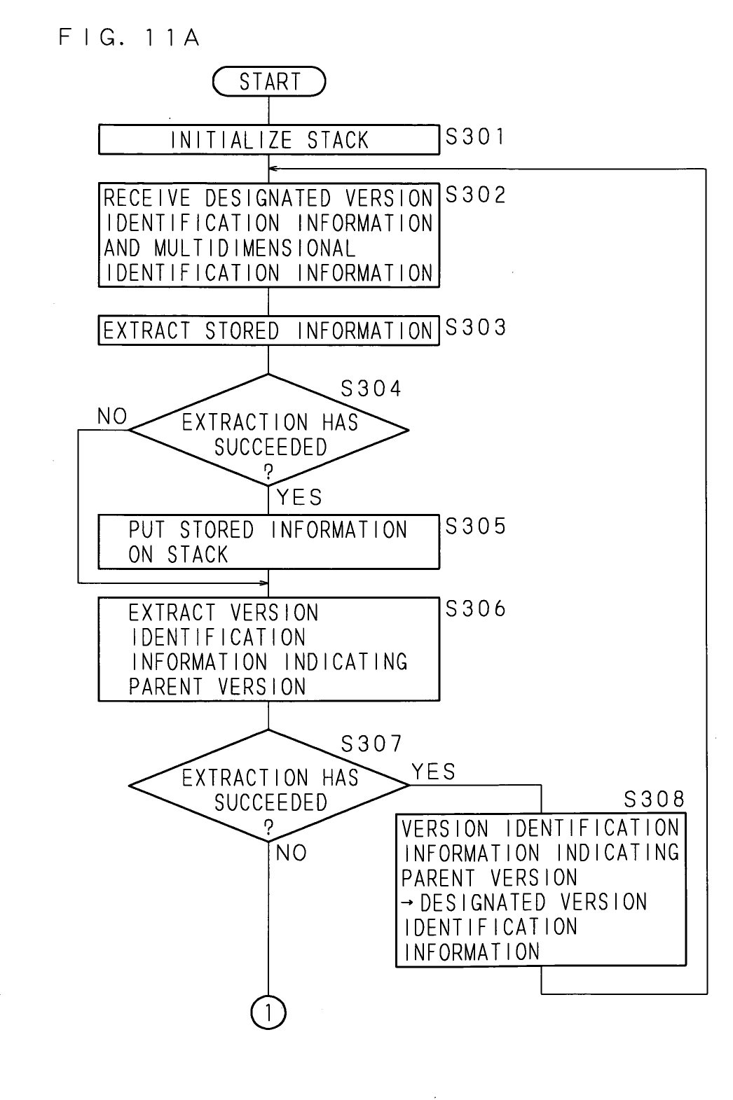

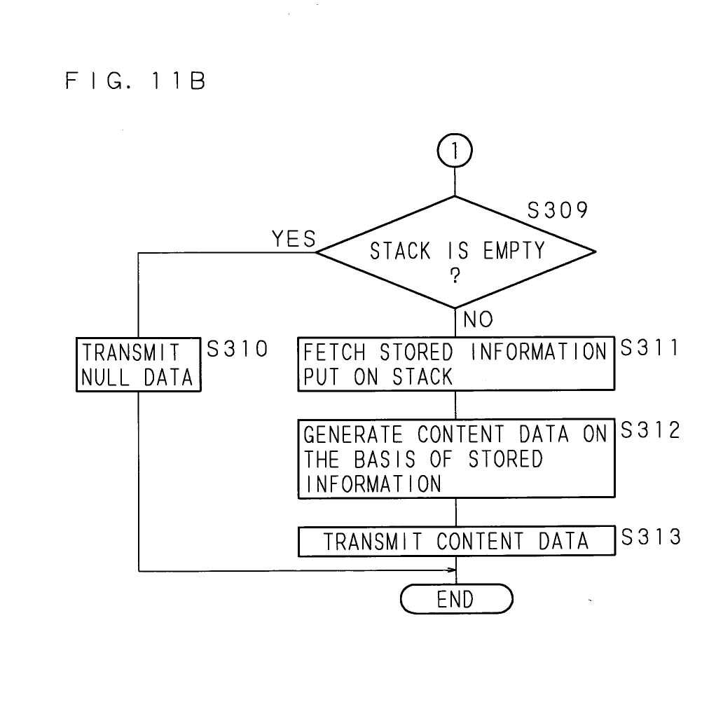

Next, the retrieval of the content data stored in the multidimensional database 2 will be described below in Embodiment 2. FIGS. 11A and 11B are flowcharts showing a retrieval procedure carried out by an information processing apparatus 1 according to Embodiment 2. For example, the user of the sales control department designates arbitrary version identification information and multidimensional identification information via the client apparatus 3 to access the working data of each branch or the completed data. The client apparatus 3 receives the designated version identification information and multidimensional identification information and transmits the received version identification information and multidimensional identification information to the information processing apparatus 1.

The CPU 18 of the information processing apparatus 1 initializes a stack allocated in the storage region in the RAM 12 (at S301). The CPU 18 receives the designated version identification information and multidimensional identification information (at S302). The CPU 18 accesses the version management table T1′ stored in the multidimensional database 2 and extracts the stored information corresponding to the version identification information and multidimensional identification information from the accessed version management table T1′ (at S303). The CPU 18 judges whether the extraction of the stored information has succeeded (at S304). As a result, when the CPU 18 judges that the extraction of the stored information has succeeded (YES at S304), the CPU 18 puts the extracted stored information on the stack (at S305). The CPU 18 accesses the hierarchic structure table T2 stored in the multidimensional database 2 and extracts the version identification information indicating the parent version from the accessed hierarchic structure table T2 (at S306).

On the other hand, when the CPU 18 judges that the extraction of the stored information has failed (NO at S304), the CPU 18 accesses the hierarchic structure table T2 stored in the multidimensional database 2 and extracts the version identification information indicating the parent version from the accessed hierarchic structure table T2 (at S306) without carrying out step S305. The CPU 18 judges whether the extraction of the version identification information indicating the parent version has succeeded (at S307). As a result, when the CPU 18 judges that the extraction of the version identification information indicating the parent version has succeeded (YES at S307), the designated version identification information is replaced with the version identification information indicating the parent version (see S302) (at S308), and the operation returns to step S302, and the retrieval procedure is repeated.

On the other hand, when the CPU 18 judges that the extraction of the version identification information indicating the parent version has failed (NO at S307), the CPU 18 judges whether the stack is empty (at S309). As a result, when the CPU 18 judges that the stack is empty (YES at S309), the CPU 18 transmits null data to the client apparatus 3 (at S310), and the retrieval procedure ends. Upon receiving the null data transmitted from the information processing apparatus 1, the client apparatus 3 judges that the content data indicated by the version identification information and multidimensional identification information designated by the user have not been stored in the multidimensional database 2.

On the other hand, when the CPU 18 judges at step S309 that the stack is not empty (NO at S309), the CPU 18 fetches the stored information put on the stack (at S311). The CPU 18 generates content data on the basis of the fetched stored information (at S312), transmits the generated content data to the client apparatus 3 (at S313), and the retrieval procedure ends. The client apparatus 3 receives the content data transmitted from the information processing apparatus 1.

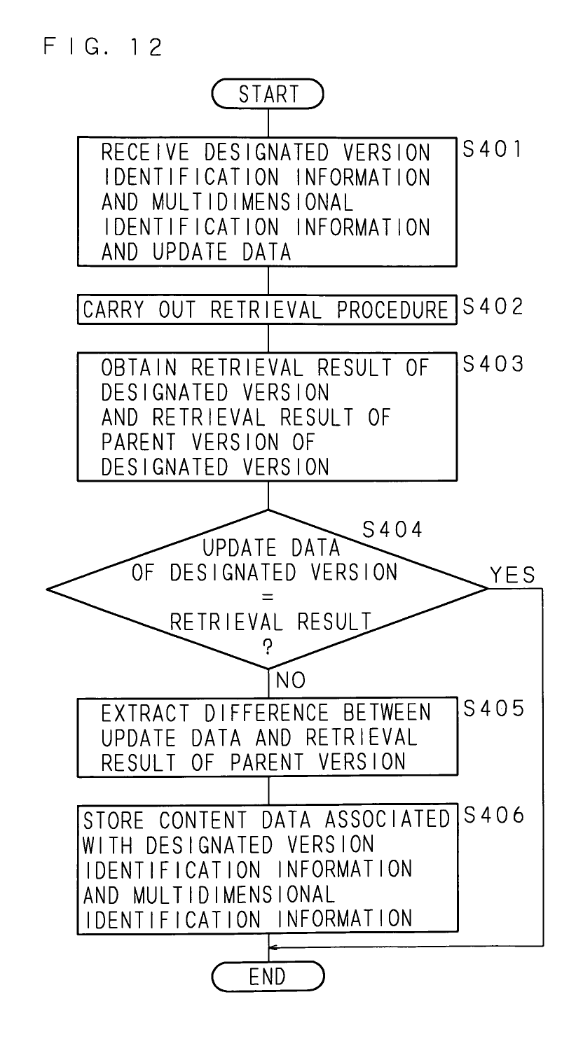

Next, the updating of the content data stored in the multidimensional database 2 will be described below. FIG. 12 is a flowchart showing an updating procedure carried out by the information processing apparatus 1 according to Embodiment 2. For example, the users of the respective departments designate arbitrary version identification information and multidimensional identification information via the client apparatuses 4 to 7 to access the working data and input update data. The client apparatuses 4 to 7 receive the designated version identification information and multidimensional identification information and the update data and transmit the received version identification information, multidimensional identification information and the update data to the information processing apparatus 1.

The CPU 18 of the information processing apparatus 1 receives the designated version identification information and multidimensional identification information and the update data (at S401). The CPU 18 accesses the version management table T1′ stored in the multidimensional database 2 and carries out the above-mentioned retrieval procedure (see FIGS. 11A and 11B) (at S402). The CPU 18 obtains the retrieval result of the version designated at step S402 and the retrieval result of the parent version of the designated version (at S403). When no parent version is available, the retrieval result of the parent version is assumed to be null data.

The CPU 18 judges whether the received update data is the same as the retrieval result of the designated version (at S404). As a result, when the CPU 18 judges that the update data is not the same as the retrieval result of the designated version (NO at S404), the CPU 18 extracts the difference between the retrieval result of the parent version of the designated version and the update data (at S405). The CPU 18 stores the extracted difference in the version management table T1′ in the multidimensional database 2 so as to be associated with the designated version identification information and multidimensional identification information (at S406), and the updating procedure ends.

On the other hand, when the CPU 18 judges that the update data is the same as the retrieval result of the designated version (YES at S404), the updating procedure ends without updating the content data on the basis of the update data.

Since the other configurations and operations according to Embodiment 2 are similar to those described in Embodiment 1, their descriptions are omitted.

In the embodiments described above, an example in which the first data structure D1 and the second data structure D2 are components of tables is described. However, without being limited to this configuration, it may be possible that the first data structure D1 and the second data structure D2 of the multidimensional database 2 are constructed by applying, for example, a method in which a markup language, such as XML, is used.

Furthermore, in the embodiments described above, an example in which the version management table T1 and the hierarchic structure table T2 are stored in the multidimensional database 2 is described. However, without being limited to this configuration, it may be possible that the tables are stored in the information processing apparatus 1.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A multidimensional database structuring method for identifying content data stored in a multidimensional database classified according to dimensions formed of a set of members, on the basis of the combination of the members, comprising steps of:
storing content data in said multidimensional database so as to be associated with version identification information for identifying the version of the content data and the combination of the members;
recording the version identification information of a predetermined version so as to be associated with the version identification information of the parent version at a hierarchic level higher than that of the predetermined version; and
identifying content data of the predetermined version on the basis of the association with the recorded version and the combination of the members.

2. A multidimensional database structuring system comprising:
a multidimensional database classified according to dimensions formed of a set of members; and
an information processing apparatus connected to said multidimensional database, the information processing apparatus having a storing section for storing content data in said multidimensional database and an identifying section for identifying the stored content data on the basis of the combination of the members;
wherein said multidimensional database includes:
a first data structure in which content data is associated with version identification information for identifying the version of the content data and the combination of the members; and
a second data structure in which the version identification information of a predetermined version and the version identification information of the parent version at a hierarchic level higher than that of the predetermined version are associated with each other;
wherein said information processing apparatus comprises:
a recording section for recording the version identification information for identifying the predetermined version so as to be associated with the version identification information of the parent version at a hierarchic level higher than that of the predetermined version in said second data structure;
wherein said storing section stores content data of the predetermined version in said first data structure so as to be associated with the version identification information and the combination of the members, and said identifying section identifies the content data of the predetermined version on the basis of the first data structure, the second data structure and the combination of the members.

3. The multidimensional database structuring system according to claim 2, wherein said first data structure and said second data structure are components of tables.

4. The multidimensional database structuring system according to claim 2, wherein the content data stored in said first data structure is the difference between the content data of the predetermined version and the content data of the parent version at a hierarchic level higher than that of the predetermined version.

5. The multidimensional database structuring system according to claim 3, wherein the content data stored in said first data structure is the difference between the content data of the predetermined version and the content data of the parent version at a hierarchic level higher than that of the predetermined version.

6. An information processing apparatus to be connected to a database capable of storing content data classified according to dimensions formed of a set of members, comprising:
a storing section for storing content data in the connected database;
an identifying section for identifying the stored content data according to the combination of the members; and
a recording section for recording the version identification information of a predetermined version so as to be associated with the version identification information of the parent version at a hierarchic level higher than that of the predetermined version;
wherein said storing section stores content data of the predetermined version so as to be associated with the version identification information and the combination of the members, and said identifying section identifies the content data of the predetermined version on the basis of the association with the recorded version and the combination of the members.
